(19) United States
(12) Patent Application Publication
(10) Pub. No.: US 2002/0098800 A1
(43) Pub. Date: Jul. 25, 2002

(54) Mobile weather reporting systems, apparatus and methods

(76) Inventors: Richard Frazita, St. James, NY (US); Lawrence Rytter, Hunt Valley, MD (US)

Correspondence Address: Thomas A. O'Rourke, Wyatt, Gerber & O'Rourke, L.L.P., 99 Park Avenue, New York, NY, 10016, US

(21) Appl. No.: 09/986,483

(22) Filed: Oct. 22, 2001

Related U.S. Application Data
(60) Provisional application No. 60/242,344, filed on Oct. 20, 2000.
(60) Provisional application No. 60/242,345, filed on Oct. 20, 2000.
(60) Provisional application No. 60/242,346, filed on Oct. 20, 2000.
(60) Provisional application No. 60/242,990, filed on Oct. 20, 2000.

(51) Int. Cl. H04B 7/185

(52) U.S. Cl. 455/12.1; 455/456; 455/414

(57) ABSTRACT

The present invention is directed to a system and method for providing digital supplementary flight information which would include more accurate weather maps, ATC traffic alerts, navigation data as well as paperless cockpit manuals/checklists/maps/ATC messages through a computer network such as for example a LAN, a WAN, an Intranet or the Internet.

Priority is claimed based on U.S. Provisional Patent Applications Serial Nos. 60/242,344, 60/242,345, 60/242,346, and 60/242,990 filed on Oct. 20, 2000 the disclosures of which are incorporated by reference.

### FIELD OF INVENTION

The present invention relates to the field of mobile weather reporting and receiving systems, apparatus and methods and has particular application for pilots, boaters and travelers to enable the to receive timely weather information through a computer network such as a LAN, WAN, an Intranet or the Internet. The present invention has particular applicability in the field of general aviation.

### BACKGROUND OF THE INVENTION

Aviation today is typically divided into two areas, general aviation and commercial aviation. In the field of commercial aviation, the aircraft tends to be larger and more expensive and is used to carry passengers and freight. Examples of commercial aviation companies include the major airlines as well as many of the regional airlines and freight carriers such as Federal Express. Commercial aviation because of the need for safety as well as to meet the demand for their services in many types of weather conditions, typically carry a weather radar. Many aircraft radar systems for commercial aviation have the ability, through their weather related radar to receive a “big picture” of the weather over their route of travel. In addition, at the present time there are proposals for a weather information network made available by the FAA, to give pilots a view of weather systems while airborne through their weather radar. This proposed system enables pilots to make routing decisions to avoid weather situations. The crews are intended to receive verbal and datalink text messages with weather updates to augment what they see on their in cockpit weather radar displays. However, the flight crew has to combine various data to understand the larger weather picture. The weather information network is intended to present a graphical composite of radar, satellite imagery, convective weather, icing and clear air turbulence information. This system, however, is in its testing stage and not been fully implemented.

Another weather reporting system is known as the cockpit weather information or CWIN. This was a NASA research program which demonstrated color coded maps obtained from ground sites and presented as graphical displays on the flight deck to permit flight crews to fly more efficient routes. The system permitted flight crews to avoid thunderstorm cells by greater distances when using this system. In addition, flight crews were able to fly shorter segments and use less fuel because of their ability to avoid weather related problems en route.

In the field of general aviation, however, most of the planes, due to the expense of weather radar, do not have access to this type of weather information while in flight. At the present time, in the field of general aviation, a pilot prior to takeoff checks an FAA terminal where he is provided with the current weather information over the flight path and destination as well as a forecast for the weather during the trip and at the time of arrival. While pilots have the ability to receive radio weather reports, these weather reports are general reports from the location where the reports originate and they typically do not contain very specific information for the pilot's current location or their direction of travel or for the general area in which they will be traveling. The FAA has had a great deal of interest in improving weather information services. At the present time the FAA provides text weather information including routine weather reports, special aviation reports, terminal area forecasts, pilot reports and severe weather forecast alerts in connection with the FAA's flight information service data link. In order to access the service, the pilots are required to have a VHF data radio and a multi function display unit capable of displaying digital graphic and text messages. The information, however, that is provided by the FISDL system is general information and is not specific to the location of the aircraft during its flight. General aviation pilots however do not have the ability to access the information for a number of reasons, one of which includes cost to access the kind of information that is typically obtained by commercial aviators.

One of the problems with the weather radar that is used on commercial aviation planes is that the radar only looks forward. It does not give the pilot information with respect to weather systems approaching from either side or the rear. For most commercial airplanes that is not as much of an issue due to their high speed and high altitude. However, for general aviation this is more important information particularly since many of the FAA routs are a plurality of point to point pathways and are not straight lines for great distances. Due to the huge amounts of traffic in many areas of the country, these routes are in numerous segments so that a trip say from New York to California in a commercial airline may not be relatively straight in some areas. In general aviation there are also a number of point to point maneuvers that are in short segments that are not purely in a straight line over long distances. In these short segments there is a need for weather information not just in the forward direction but also from side to side and sometimes from the rear. This information is not available from a on board weather radar.

### SUMMARY OF THE INVENTION

The present invention is directed to a system and method for providing digital supplementary flight information which would include more accurate weather maps, ATC traffic alerts, navigation data as well as paperless cockpit manuals/checklists/maps/ATC messages through a computer network such as for example a LAN, a WAN, an Intranet or the Internet. In addition, the pilot, crew and passengers would be able to have e-mail, video conferencing, digital voice communication, fax and other internet access while en route. Depending on the needs of the pilot, there may also be digital voice communication access to corporate intranet, TV and audio and interactive games. The present invention includes a mobile satcom platform with tracking antenna. This platform may be an airplane, boat, vehicle or any other mobile transportation device. The transportation device should have a GPS system whereby its position on the earth surface can be determined with relative accuracy. Having the GPS system permits the system of the present invention to provide local weather information by means of a computer oriented system with access to an internet connection on the airplane as described in more detail below. The computer system accesses the internet through a wireless modem. The network such as the Internet is used to obtain localized weather information from one of the numerous sources available. These sources primarily have access to local radar information on a real time basis whereby the user in the airplane, boat, car or other mobile device using the wireless internet modem can access relevant websites designed to take the vehicles position from the GPS satellite system and provide local weather and other data to the user. This weather information can include information with respect to the direction of travel of the vehicle and also in a 360 radius so that the user has an opportunity to view the weather situation all around them.

### BRIEF DESCRIPTION OF THE DRAWINGS

FIG. 1 shows an example of the system of the present invention.

FIG. 2 shows a block diagram of a representative computer system that would be used by the mobile vehicle to access information over a network such as a LAN, Wan, the Internet or an Intranet.

FIG. 3 is a block diagram of a system that allows access to a software application over the World-Wide Web from a standard web browser;

### DETAILED DESCRIPTION OF THE INVENTION

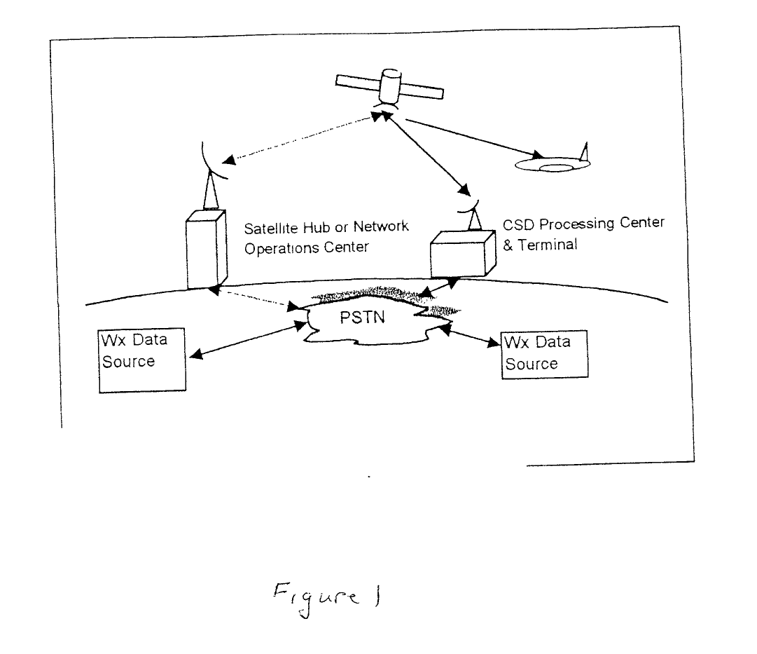

As seen in FIG. 1 there is a mobile vehicle, in this instance an airplane. However, it will be appreciated by those skilled in the art that the airplane could also be a ship, car, truck, train or other mobile traveling device. The vehicle has a Global Positioning System (GPS) system on board which will provide through a satellite accurate information on the location of the vehicle in relation to the earth surface. The Global Positioning System (GPS) is a constellation of about 24 artificial satellites. The GPS satellites are uniformly distributed in a total of six orbits such that there are four satellites per orbit. This number of satellites and spatial distribution of orbits insures that at least eight satellites can be simultaneously seen at any time from almost anywhere on Earth. The GPS satellites circle the Earth at an altitude of about 20,000 km (13,000 miles) and complete two full orbits every day. The GPS satellites are not in a geostationary orbit, but rise and set two times per day. Each satellite broadcasts radio waves towards Earth that contain information regarding its position and time. A vehicle can receive this information by using special receivers, called GPS receivers, which can detect and decode this information. By combining signals transmitted by several satellites and received simultaneously, a GPS receiver can calculate its position on the Earth (i.e., its latitude and longitude) with an accuracy of approximately 10 m. There are more sophisticated receivers that can be used to determine position with an accuracy of a few millimeters.

Using the accurate information obtained by a GPS receiver, a wireless modem on the vehicle can transmits to a satellite a request for weather or other information. The satellite in turn submits the request to the satellite hub or network operation center and/or the processing center and terminal. Either of these two centers can access local weather information in their respective areas, submit that weather information over the wireless modem connection to the satellite and then in turn to the mobile vehicle.

In a preferred embodiment of the invention, the moving vehicle has a mobile satcom platform with a tracking antenna to provide access to local communications network. These networks can provide the requested information over the Internet. In addition to localized weather information the service may include specialized data bases to provide information to the pilot or other user of the mobile device information a subscription basis. Many pilots in general aviation lack the funds or the interest in having weather radar on their planes. The present invention provides a low cost means to give these pilots the same information if not more accurate information concerning their destination, their path of travel and their current location without the cost and expense of weather related radar. Information could be obtained over the internet from the FAA and its weather data bank of information including short term forecasts. The availability of the FAA's short term forecasts is a significant improvement over the information that is currently available to pilots in general aviation.

The short term forecasts are very localized forecasts over very short periods of time, typically about fifteen minutes or less. These short term forecasts can be very useful to pilots because they will give them up to date information as to weather problems that are just short distances ahead that a weather radar on a commercial airplane could provide but not having access to this weather radar on board the plane they do not have this information available. The short term forecasts are typically called micro forecasts. One source for the weather forecast or the weather information could be the FAA's Nexrad weather stations that are blanketed across the United States at various locations. The Nexrad weather stations can provide information on such weather phenomenon as sleet, hail, rain that normal weather radar cannot.

In addition to the FAA Nexrad weather stations there are also at numerous places across the country commercial weather stations such as ACCU weather which can also provide weather information to the vehicle on a very timely basis. The present invention would provide weather information on a more timely basis than even such commercial television weather programs as The Weather Channel because such information shown on that channel is typically delayed 15 to 20 minutes in view of the processing that occurs to put the information in a graphic interface and to provide additional information. The information with respect to micro forecasts is particularly useful in navigation of airplanes because the information is very timely and would permit the pilot to determine whether or not he can fly over thunderstorms for example or whether he should re-route the plane around the weather system in front of the pilot. The micro forecast radar provided through this invention would provide timely weather information similar to the weather information provided by weather radar, but would include rear and side information with respect to weather systems. The uniqueness of the present invention includes such factors as the ability to interact with the Internet as opposed to relying on the terminals at individual airports that each pilot would check before leaving on a flight.

The weather information that is provided by the system of the present invention may be shown on a video screen built into the vehicle or can be shown on a laptop or other computer system that is added onto the vehicle. The Internet connection is preferably a broadband connection so that the graphic data information can be provided on a high speed basis. However, slower speeds of 56 k or less may also be used that you would typically find in a standard wireless telephone type network connection. Another disadvantage of the cell phone wireless type communication connection for the network connection is that for many boating and aircraft trips there is a significant risk that the vehicle will be outside of the cellular network. Accordingly, a broadband network connection with the satellite is the preferred method of communication. In a preferred embodiment the antenna on board the vehicle would be of the type shown in co-pending provisional patent applications Serial Number: ______ filed concurrently herewith and Serial Number: ______ filed concurrently herewith, the disclosures of which are incorporated herein by reference. The vehicle should also in a preferred embodiment have a stabilized platform so that differences in height, pitch and yaw should not effect the readings of the satellite and also the network connection thereto. The stabilizer would include a gyroscope to stabilize the beam from the vehicle to the satellite.

The present invention is directed to a system and more preferably a computer network for accessing the information on a network, such as the Internet. The term computer network as used herein is used in its broadest sense i.e. as any configuration of data processing devices and software connected for information exchange. The present invention can include personal computers, personal digital assistants (PDA's), set top boxes used on or in connection with televisions, and any other type of appliance that can access a collection of data such as the Internet.

In one embodiment the appliance can include a network that serves to connect together a plurality of devices, e.g., terminals, computers, etc. Networks typically comprise a plurality of devices such as computers some of which function as servers to provide services to the other computers connected to the network. There are many types of computer networks in existence. They are known by various names including Local Area Network (LAN), Wide Area Network (WAN), Internet and the like and may be implemented in accordance with a variety of known architectures.

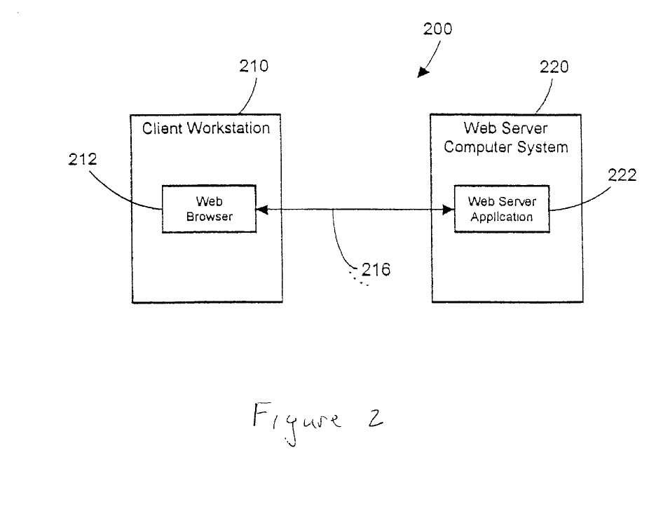

Referring to FIG. 2, in one embodiment of the invention there is a typical transaction between a standard web browser 212 running on a client workstation 210 and a web server application 222 running on a web server computer system 220 occurs over a connection (communication link or communication mechanism) 216. Client workstation 210 may be coupled to other computer systems via a local area network (LAN) or via any other type of computer network or other interconnection. Likewise, web server computer system 220 may be coupled to other computer systems as well. Client workstation 210 may be any computer that is capable of providing access to the WWW by using web browser 212. This would include handheld, portable or laptop computers, standard desktop computer systems, etc.

Web browser 212 is a software program running on client workstation 210 that allows a user at client workstation 210 to communicate with other computers over connection 216. Web browser 212 would include any web browser, which is capable of transmitting and receiving data over the WWW. This includes commercial software applications such as IBM's WebExplorer, Internet Netscape Navigator, Microsoft Explorer, Apple Computer's CyberDog, and any other software application which now exists or which may be developed in the future for accessing or processing information over the WWW. The preferred embodiment for connection 216 is any suitable wireless communication link or wireless communication mechanism to the Internet, including infrared or other wireless communications, wireless computer network communications, or any other suitable connection between computers, whether currently known or developed in the future.

It should be noted that client workstation 210 and web server computer system 220 may be the same physical and/or logical computer system. Web browser 212 typically displays pages of data including but not limited to data in the form of HTML, XML, XHTML or their future incarnations to a user at client workstation 210. Other types of data (besides HTML) may also be transmitted to web browser 212, including text data, graphical data (e.g., Graphic Image Format (GIF) files), audio data or sound files (e.g., WAV files), Java applets (executable code) and a specialized data form known as Multipurpose Internet Mail Extensions (MIME) data (which may include combinations of the foregoing and other data types).

Web server application 222 is a software program running on web server computer system 220 that allows a user at client workstation 210 to access information controlled by web server 220. One preferred embodiment of web server application 222 in accordance with the present invention is a commercial web server application such as IBM's Internet Connection Server. Other applications are also compatible with the present invention. Web server computer system 220 typically outputs pages of HTML data to WEB browser 212 in response to requests by web browser 212 that reflect action taken by the user at client workstation 210. In addition, as explained above, web server computer system 220 may output other types of data to web browser 212 as well. Output data may include static HTML pages (meaning that the content of the page does not vary), or may include data that must be dynamically determined and inserted into the output data. Web server application 222 may dynamically build output data (e.g, an HTML page) from parts that it retrieves from memory within web server computer system 220 or from other computer systems, or may simply pass through a page that has been constructed at an earlier time or by another computer.

Web browser 212 typically interacts with web server application 222 by transmitting input (e.g., a Uniform Resource Locator (URL) or an HTML page) over connection 216 to web server computer system 220. This input is typically transmitted using HyperText Transfer Protocol (HTTP) 1.0. Web server computer system 220 running web server application 222 receives the input from web browser 212, and in response, outputs data (e.g., an HTML page) to browser 212. Web server computer system 220 may also have numerous other software components, including Common Gateway Interface (CGI) programs or modules, for performing desired functions. The process described above illustrates a basic transaction over the Internet, recognizing that many details and variations that are within the scope of the present invention are not disclosed herein for the purpose of providing a simple context for understanding the concepts of the present invention.

Web Pages

A web page is primarily visual data that is intended to be displayed on the monitor of client workstation 210. Web pages are generally written in Hypertext Markup Language (HTML). However they can be written in XML, XHTML or their future incarnations. When web server application 222 running on web server computer system 220 receives a web page request, it will build a web page in HTML or retrieve a file containing a pre-built web page and send it off across connection 216 to the requesting web browser 212. Web browser 212 understands HTML and interprets it and outputs the web page to the monitor of client workstation 210. This web page displayed on the user's screen may contain text, graphics, and links (which are URL addresses of other web pages.) These other web pages (i.e., those represented by links) may be on the same or on different web servers. The user can retrieve these other web pages by clicking on these links using a mouse or other pointing device. This entire system of web pages with links to other web pages on other servers across the world collectively comprises the “World-Wide Web” (WWW).

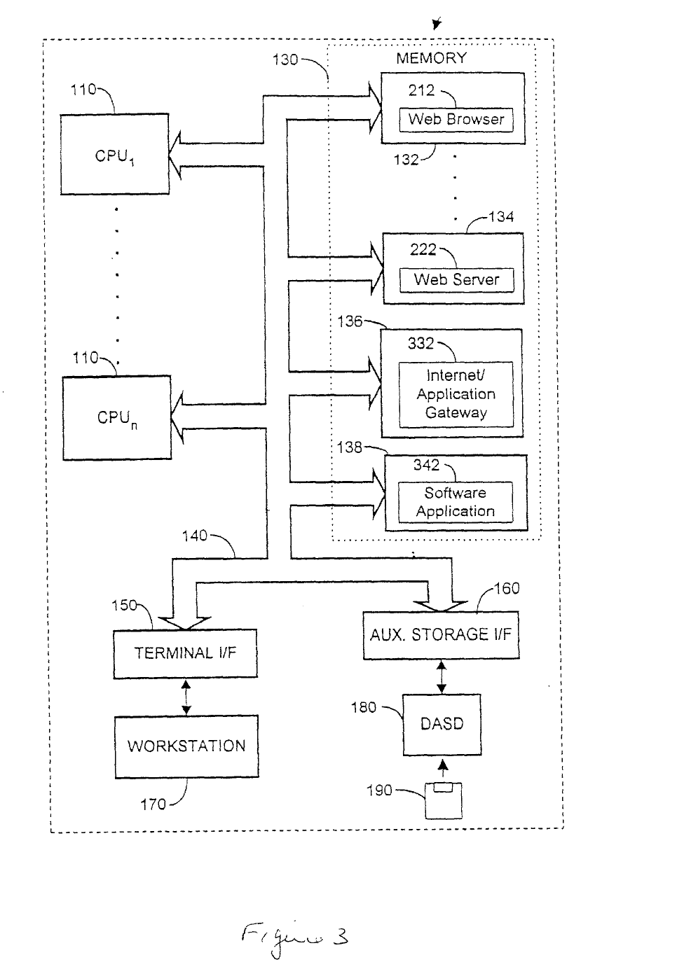

Referring now to FIG. 3, a computer system in accordance with one embodiment of the present invention may include: one or more Central Processing Units (CPUs) 110; a terminal interface 150; an auxiliary storage interface 160; a workstation 170; a Direct Access Storage Device (DASD) 180; a floppy disk 190; a bus 140; and a memory 130 which includes multiple locations for containing various software programs. In this example, memory 130 includes a web browser 212 running in location 132, a web server application 222 running in location 134, an Internet/application gateway program 332 running in location 136, and a software application 342 running in location 138.

CPUs 110 perform computation and control functions of system 100. All CPUs associated with system 100 may each individually comprise a single integrated circuit, such as a microprocessor, or may comprise any suitable number of integrated circuit devices and/or circuit boards working in cooperation to accomplish the functions of a central processing unit. All CPUs are capable of suitably executing the programs contained within memory 130 and acting in response to those programs or other activities that may occur in system 100.

Memory 130 is any type of memory known to those skilled in the art. This would include Dynamic Random Access Memory (DRAM), Static RAM (SRAM), flash memory, cache memory, etc. While not explicitly shown in FIG. 3, memory 130 may be a single type of memory component or may be composed of many different types of memory components. For example, web browser 212 running in location 132 may be part of system 100's cache memory. In addition, memory 130 and CPUs 110 may be distributed across several different computer that collectively comprise system 100. For example, web browser 212 may reside on one computer with CPU,, web server application 222 may reside on another computer system with a separate CPU.sub.2, Internet/application gateway 332 may reside on a third computer system with a different CPU.sub.n-1, and software application 342 may reside on a fourth computer with a different CPU.sub.n. Computer system 100 of FIG. 3 simply illustrates many of the salient features, without limitation regarding the physical location of CPUs 110 or memory locations within memory 130.

Bus 140 serves to transmit programs, data, status and other forms of information or signals between the various components of system 100. The preferred embodiment for bus 140 is any suitable physical or logical means of connecting computer systems and components known to those skilled in the art. This includes, but is not limited to, direct hard-wired connections, Internet connections, Intranet connections, fiber optics, infrared (IR) and other forms of wireless connections. It is anticipated that many alternative methods and material for connecting computer systems and components will be readily adapted for use with the present invention. This would include those methods and materials not presently known but developed in the future.

Terminal interface 150 allows human users to communicate with system 100, normally through programmable workstation 170. Although system 100 as depicted in FIG. 11 contains only a single workstation 170, it should be understood that the actual number of workstations attached to system 100 will be a function of system design and user preference. Workstation 170 may also be a dumb terminal or other non-programmable computer input/output device which allows human interaction with computer system 100.

Auxiliary storage interface 160 represents any method of interfacing a storage apparatus to a computer system known to those skilled in the art. Auxiliary storage interface 160 allows auxiliary storage devices such as DASD 180 to be attached to and communicate with the other components of system 100. While only one auxiliary storage interface 160 is shown, the present invention anticipates multiple interfaces and multiple auxiliary storage devices such as DASD 180. As shown in FIG. 3, DASD 180 may be a floppy disk drive which is capable of reading and writing programs or data on floppy disk 190. DASD 180 may also be any other type of DASD known to those skilled in the art. This would include CD-ROM drives, hard disk drives, optical drives, etc. Floppy disk 190 represents a typical 3.5 inch magnetic media disk known to those skilled in the art.

We claim:

1. A system for providing digital information to a vehicle comprising a GPS system whereby the position of the vehicle on the earth surface can be determined with relative accuracy, a mobile satcom platform with tracking antenna to provide access to a local communications network based on the position of the vehicle determined by the GPS system, said vehicle obtaining from said communications network specific information based on the location of the vehicle as determined by the GPS system.

2. The system according to claim 1 wherein the vehicle is an airplane.

3. The system according to claim 1 wherein the vehicle is a ship.

4. The system according to claim 1 wherein the information includes weather information specific to the location of the vehicle.

5. The system according to claim 4 wherein the weather information is a micro forecast.

6. The system according to claim 4 wherein the weather information is obtained from the FAA.

7. The system according to claim 1 wherein the information obtained is obtained from the world wide web.

8. A system for providing digital information to a vehicle comprising a GPS system whereby the position of the vehicle on the earth surface can be determined with relative accuracy, a wireless modem on the vehicle to transmit to a satellite a request for information specific to the location of the vehicle, receiving from said satellite information specific to the location of the vehicle.

9. The system according to claim 8 wherein the vehicle is an airplane.

10. The system according to claim 8 wherein the vehicle is a ship.

11. The system according to claim 8 wherein the information includes weather information specific to the location of the vehicle.

12. The system according to claim 11 wherein the weather information is a micro forecast.

13. The system according to claim 11 wherein the weather information is obtained from the FAA.

14. The system according to claim 8 wherein the information obtained is obtained from the world wide web.

15. A method for providing digital information to a vehicle, said digital information being specific to the location of the vehicle, comprising determining the location of the vehicle on the earth's surface using a GPS system, transmitting to a satellite a request for information specific to the location of the vehicle, said satellite in turn submitting the request to a network, accessing information specific to the vehicle from the network based on the location of the vehicle on the earth's surface.

16. The method according to claim 15 wherein the request for information transmitted to the satellite is transmitted by a wireless modem.

17. The method according to claim 15 wherein the satellite submits the request to a satellite hub.

18. The method according to claim 15 wherein the satellite submits the request to a network operation center.

19. A system for providing digital information to a vehicle comprising a GPS system whereby the position of the vehicle on the earth surface can be determined with relative accuracy, a wireless modem on the vehicle to transmit to a satellite a request for information from a network in the vicinity of the location of the vehicle, receiving from said satellite the requested information.

20. A method for providing digital information to a vehicle, comprising determining the location of the vehicle on the earth's surface using a GPS system, transmitting to a satellite a request for information, said satellite in turn submitting the request to a network in the vicinity of said vehicle, accessing information from the network based.
